(19) United States
(12) Patent Application Publication
(10) Pub. No.: US 2014/0358730 A1
(43) Pub. Date: Dec. 4, 2014

(54) Systems And Methods For Optimally Ordering Recommendations

(71) Applicant: Wal-Mart Stores, Inc., Bentonville, AR (US)

(72) Inventors: Kannan Achan, Mountain View, CA (US); Afroza Ali, Sunnyvale, CA (US); Ron Benson, San Francisco, CA (US)

(21) Appl. No.: 13/905,702

(22) Filed: May 30, 2013

(51) Int. Cl. G06Q 30/06

(52) U.S. Cl. CPC G06Q 30/0631; G06Q 30/0623
USPC 705/26.61

(57) ABSTRACT

Example systems and methods for optimally ordering recommendations or search results are described. In one implementation, a method determines a set of items as search results or candidates for recommendation. Each of the items in the set is associated with a respective first parameter representative of a measure of suitability of the respective item for recommendation. The items in the set are associated with a plurality of second parameters each of which representative of a measure of similarity between a respective one of the items and another respective one of the items. The method also determines an order in which a subset of the items is to be displayed based at least in part on the representative first parameter and the representative set of second parameters associated with the items. The method further displays the subset of the items in the determined order.

### TECHNICAL FIELD

The present disclosure relates to systems and methods for optimally ordering recommendations and, in particular, to systems and methods for optimally ordering recommendations using a pairwise similarity measure.

### BACKGROUND

Electronic commerce, commonly known as e-commerce, has become a popular way of shopping for many in recent years. When an online shopper, or e-commerce user, visits an e-commerce website to browse and/or purchase items, the e-commerce website typically advertises one or more recommended items related to an item the user is browsing or purchasing at a given time. Thus, recommendation systems are at the heart of retail e-commerce business. These systems are primarily driven by data logs pertaining to the usage patterns of customers visiting the e-commerce website. For example, if it is observed that a significant set of e-commerce users, e.g., online shoppers, purchased a particular camera along with a particular carrying case, then it is reasonable to recommend that particular carrying case to new users who are expected to buy the particular camera. Hence, at the core of a recommendation system, patterns pertaining to user activity (e.g., view, purchase, etc.) are mined for actionable trends which then form the basis for recommendations. While identifying items for recommendation is crucial, the task of presenting the recommendation is of importance as well.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an example framework of the present disclosure.

FIGS. 2A and 2B are diagrams depicting example algorithms implemented in systems and methods of the present disclosure.

FIGS. 3A and 3B are diagrams depicting a comparison between results of a conventional recommendation algorithm and an example recommendation algorithm implemented in systems and methods of the present disclosure.

FIG. 4 is a block diagram depicting an embodiment of a computing device configured to implement systems and methods of the present disclosure.

FIG. 5 is a flowchart diagram of an embodiment of a process of the present disclosure.

FIG. 6 is a flowchart diagram of another embodiment of a process of the present disclosure.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

In a setting where n candidate items and p positions/slots/place holders are given (n>p), ordering the candidate items using only a “goodness” function, that is related to the suitability for recommendation, requires a trivial sort and subsequently selecting the top p candidate items. Given that n is relatively small (tens or at most a few hundreds), this approach can be done relatively efficiently. However, finding an optimal ordering in the presence of a “similarity” function, that is related to the similarity between two candidate items, tends to complicate the computation significantly. In such case all possible combinations of size p using n elements, i.e., N(n, p) combinations, would need to be evaluated. For a set of 20 candidate items and 10 available positions, a brute force approach would result in scoring 184,756 configurations, which is not practicable in a production environment.

The systems and methods described herein address the problem of finding an optimal ordering for a given set of recommendations or search results, subject to a given set of constraints. The present disclosure proposes an algorithm that takes additional information as input and utilizes the additional information in selecting and ordering a subset of candidate items for display to an e-commerce user. As will be explained further below, in some embodiments, the algorithm proposed in the present disclosure takes the following as input: (1) a set of candidate items that are desirable or suitable for recommendation with respect to a given item of interest (e.g., an item that an e-commerce user is currently viewing or purchasing, or has viewed or purchased in the past by the e-commerce user, an item added to a wish list of a shopping cart of the e-commerce user, or an item purchased offline in a physical store by the e-commerce user), (2) a first parameter (e.g., weight φᵢ for each item i suggesting its goodness or suitability for recommendation) associated with a respective item in the set, that represents a measure of suitability of the respective item for recommendation, for each item in the set, and (3) a set of second parameters (e.g., similarity measures Ψ_{i,j} each of which representative of a measure of similarity between a respective one of the items and another respective one of the items.

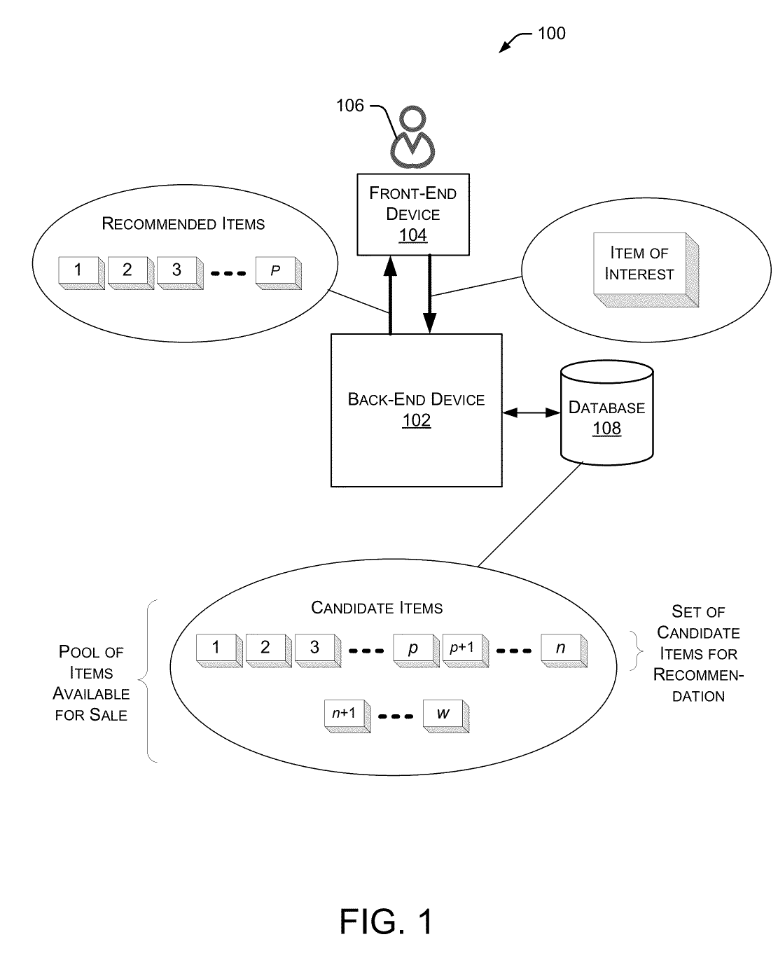

FIG. 1 is a block diagram depicting a framework 100 within which an example embodiment of the present disclosure may be implemented. Framework 100 includes back-end device 102 and front-end device 104. Back-end device 102 may include one or more processors that execute operations pertaining to algorithms described in the present disclosure. Optionally, database 108 may be communicatively coupled to back-end device 102 to cache or otherwise store some or all of the information and data received, collected and processed by the one or more processors of back-end device 102. In some implementations, database 108 may be an integral part of back-end device 102. Back-end device 102 may be any type of computing device such as, for example, one or more of a desktop computer, a workstation, a server, a mainframe computer, a portable device, etc. Front-end device 104 may be any type of user-interface device including, for example, a combination of one or more of a display panel, a monitor, a keyboard, a computer mouse, a stylus, a keypad, a touch-sensing screen, a voice-command device, or any suitable user-interface device conceivable in the future. Alternatively, front-end device 104 may be any type of computing device such as, for example, a desktop computer, a workstation, a laptop computer, a notebook computer, a tablet, a smartphone, a personal digital assistant, or any suitable handheld device.

Back-end device 102 and front-end device 104 may be integral parts of an apparatus or, alternatively, may be communicatively coupled directly or indirectly through one or more communication devices or one or more networks. In implementations where back-end device 102 and front-end device 104 communicate with one another through one or more networks, the one or more networks may include, for example, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN) or the Internet. In implementations where back-end device 102 and front-end device 104 communicate with one another through one or more networks including at least one wireless network, the at least one wireless network may be, for example, based on one or more wireless standards such as IEEE 802.11 standards, WiFi, Bluetooth, infrared, WiMax, 2G, 2.5G, 3G, 4G, Long Term Evolution (LTE) and/or future versions and/or derivatives thereof.

User 106, an online shopper and interchangeably referred to as e-commerce user herein, operates front-end device 104 to access back-end device 102. For example, through front-end device 104, user 106 browses the website of an e-commerce merchant, which is hosted on back-end device 102, and selects or otherwise identifies an item (referred to as “item of interest”) by taking an action with respect to the item of interest such as, for example, viewing or purchasing the item of interest. In response, back-end device 102 provides a number of candidate items as search results or for recommendation that may be suitable to be purchased by user 106 in view of the item of interest. The candidate items are displayed or otherwise presented to user 106 by front-end device 104 in a specific order, e.g., listed in an order that is determined at least in part based on the suitability for a predefined purpose (e.g., recommendation) of each candidate item and similarity between each candidate item and other possible candidate items from a pool of items available for sale.

Database 108 maintains a database of a pool of items, e.g., goods, that are available for sale by the e-commerce merchant on its e-commerce website. As shown in FIG. 1, the pool of items available for sale includes items 1, 2, 3, . . . w. When back-end device 102 receives from front-end device 104 an indication of selection by user 106 of an item of interest, back-end device 102 accesses database 108 and dynamically identifies, determines or otherwise generates a set of candidate items as search results or for recommendation in view of the item of interest. The set of candidate items as search results or for recommendation includes items 1, 2, 3, . . . n, where n<w. Utilizing algorithms described in the present disclosure, back-end device 102 determines an order in which a subset of the candidate items is to be displayed to user 106 based at least in part on a respective first parameter associated with each of the items in the pool and a set of second parameters associated with the items in the pool. The subset of candidate items as search results or for the predefined purpose (e.g., recommendation) includes items 1, 2, 3, . . . p, where p<n. Back-end device 102 then communicates with front-end device 104 to display or otherwise present the subset of candidate items to user 106 in the specific order determined by back-end device 102.

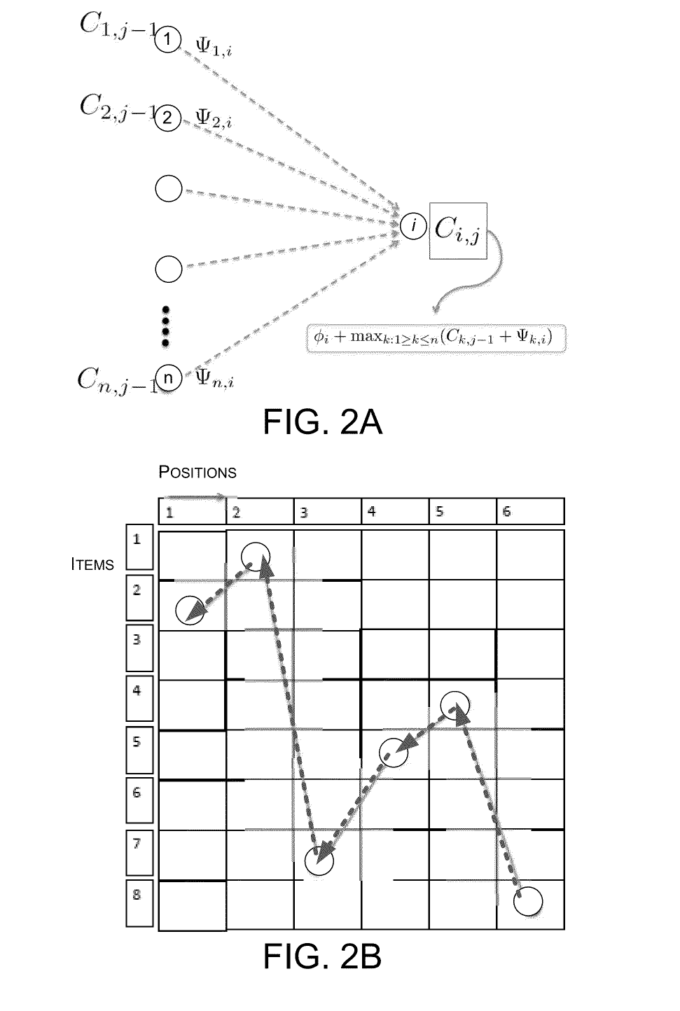

FIG. 2A illustrates an example algorithm implemented in systems and methods of the present disclosure. Referring to FIG. 2A, a dynamic programming grid C_{i,j} denotes the best cost arrangement of candidate items up to position j that places item i in position j. C_{i,j} is defined, for j>1, as follows:

C_{i,j}=φᵢ+max_{k:1≧k≦n}(C_{k,j-1}+Ψ_{k,i}).

In the above equation, i denotes an i^{th} item of the set of items, 1≦i≦n; n denotes a quantity of items in the set of items, n≧1; j denotes a position in the order in which a subset of the items is to be displayed, 1<j≦p, where p is a quantity of items in the subset of the items, n>p; C_{i,j} denotes a best cost arrangement of the items up to position j that places item i in position j; φᵢ denotes a respective first parameter representative of a measure of suitability of the i^{th} item for recommendation; and Ψ_{k,i} denotes a respective one of the second parameters representative of a measure of similarity between a k^{th} item and the i^{th} item.

For j=0, the algorithm sets C_{i,0}=φ₀. Along with C_{i,j}, the best item from position j−1, which is credited with the cost in an array B, is also stored. In other words, the argmax of the max operation is stored in the array B. It is noteworthy that C_{i,j} corresponds to the cost associated with the best cost configuration, even though all items in the previous position are examined (see FIG. 2A). There are a total of pn elements in the table and populating the table incurs a complexity of O(n²p)—each of the pn entry requires a max operator that is linear in n.

Once the dynamic programming grid C is loaded, the optimal configuration of items for recommendation and corresponding positions in an order to be displayed can be inferred using a Viterbi-style backtracking algorithm. FIG. 2B illustrates an example backtracking algorithm of the present disclosure, which is a decoding procedure that finds the single best configuration of items and the corresponding positions. The backtracking algorithm begins by finding the best item a in the last position p, which corresponds to the maximum element in the last column C. The algorithm then backtracks to the item b in position p−1 that originally led to item a. This process is repeated until the first position is reached and the backtracked path reveals the best cost arrangement of items and their respective positions in the order in which this subset of items from the set of candidate items is to be displayed. In the example shown in FIG. 2B, the best item in the last position, position 6 (item 8 in this example), is first identified by computing max(C1,p, C2,p, . . . Cn,p). The algorithm then backtracks to the item that accounted for the best cost from the previous position, position 5, and so on. The algorithm continues backtracking until item that accounted for the best cost from the first position, position 1. At this point, the best configuration or lineup of a subset of candidate items from the initial lot of candidate items are selected and each item in the subset is slotted for a respective position in the order in which the subset of items is to be displayed to the e-commerce user.

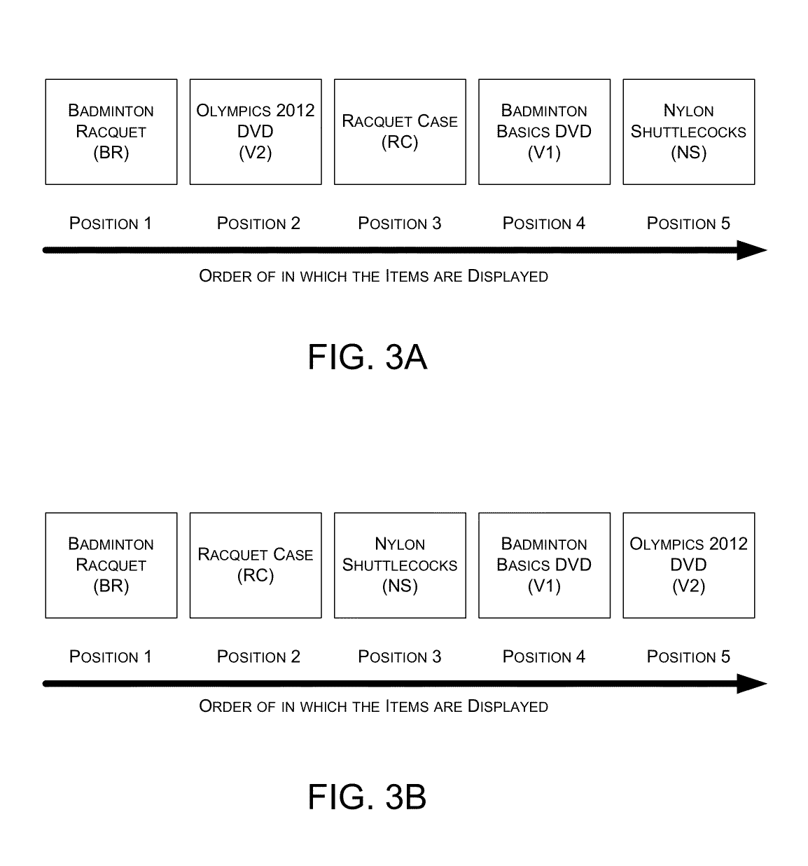

FIGS. 3A and 3B illustrate a comparison between results of a conventional algorithm and an example algorithm implemented in systems and methods of the present disclosure. Conventional recommendation algorithms tend to use the first parameter, the measure of goodness or suitability for recommendation, as the sole criterion in deciding the ordering. Accordingly, conventional recommendation algorithms typically sort the set of candidate items by the first parameter. In contrast, systems and methods in accordance with the present disclosure utilize additional information about the compatibility of items in the final ordering. Take, for example, a badminton racquet (BR), a racquet case (RC), nylon shuttlecocks (NS) and two different video media (V1 and V2) on learning badminton as the candidate items under consideration and suppose the weights of suitability for recommendation of BR, RC, NS, V1 and V2 are 0.75, 0.65, 0.55, 0.60 and 0.7, respectively. As shown in FIG. 3A, an ordering based on just the weights of suitability for recommendation would result in BR, V2, RC, V1 and NS. From the perspective of user experience, listing the candidate items in such order might not be appealing. On the other hand, as shown in FIG. 3B, using the algorithm of the present disclosure, an ordering of the candidate items would result in BR, RC, NS, V1 and V2 or, alternatively, V1, V2, BR, RC, NS. In either case, the listing of the candidate items for recommendation in such order would be visually more engaging and appealing.

Systems and methods described herein help e-commerce merchants to advertise to online shoppers items for recommendation in a visually engaging and appealing way. The recommended items are displayed in an order that is determined not only based on the suitability for recommendation of the item but also the similarity between each item and the other items that are candidates for recommendation. Advantageously, this would stimulate more interest in the recommended items from the online shopper's perspective and result in more sales for the e-commerce merchant.

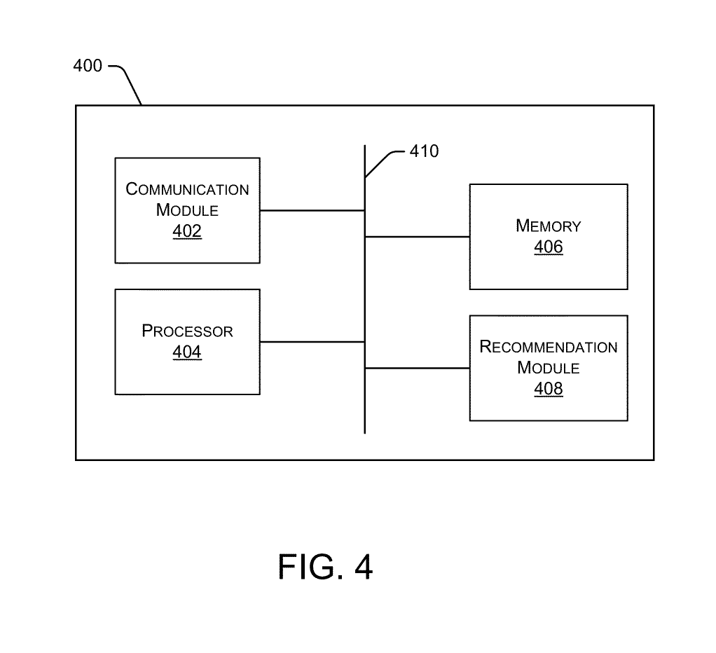

FIG. 4 illustrates an example computing device 400 configured to implement systems and methods of the present disclosure. Computing device 400 performs various functions related to the operation of back-end device 102, as discussed herein. In some embodiments, back-end device 102 includes multiple ones of computing device 400 that cooperatively implement the functions described herein. Computing device 400 includes a communication module 402, a processor 404, and a memory 406. Communication module 402 allows computing device 400 to communicate with other systems, such as communication networks, other servers, front-end device 104, etc. Processor 404 executes one or more sets instructions to implement the functionality provided by computing device 400. Memory 406 stores those one or more sets of instructions as well as other data used by processor 404 and other modules contained in computing device 400. Computing device 400 also includes a recommendation module 408, which determines optimally ordering recommendation or search results with respect to a set of candidate items as described herein. For illustrative purposes, recommendation module 408 is shown in FIG. 4 as an individual module separate from processor 404. In some implementations, however, recommendation module 408 may be an integral part of processor 404. A data communication bus 410 allows the various systems and components of computing device 400 to communicate with each other.

Memory 406 may store data and one or more sets of instructions, and processor 404 may execute the one or more sets of instructions and control communication module 402 and recommendation module 408. For example, processor 404 may control recommendation module 408 to determine a set of items as search results or candidates for recommendation. Each of the items in the set is associated with a respective first parameter representative of a measure of suitability of the respective item for a predefined purpose (e.g., recommendation). The items in the set are associated with a plurality of second parameters each of which representative of a measure of similarity between a respective one of the items and another respective one of the items. Processor 404 may also control recommendation module 408 to determine an order in which a subset of the items is to be displayed based at least in part on the representative first parameter associated with each of the items and the representative set of second parameters associated with the items. Processor 404 may further control communication module 402 to communicate with a display device, e.g., front-end device 104 which has a screen or display panel, to display the subset of the items in the determined order.

As another example, processor 404 may receive, through communication module 402, an indication of a selection of an item of interest. Processor 404 may control recommendation module 408 to determine a set of items as search results or candidates for recommendation with respect to the item of interest. Each of the items in the set is associated with a respective first parameter representative of a measure of suitability of the respective item for a predefined purpose (e.g., recommendation). The items in the set are associated with a plurality of second parameters each of which representative of a measure of similarity between a respective one of the items and another respective one of the items. Processor 404 may further control communication device 402 to communicate with a display device, e.g., front-end device 104 which has a screen or display panel, to display a subset of the items in a specific order based at least in part on the representative first parameter associated with each of the items and the representative set of second parameters associated with the items.

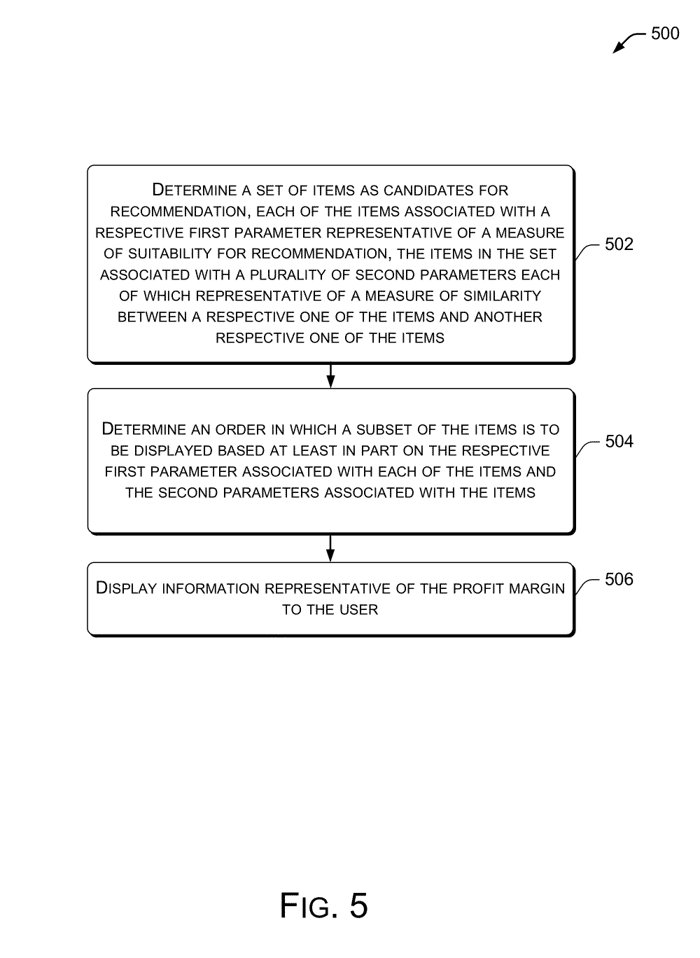

FIG. 5 illustrates an example process 500 for optimally ordering recommendation or search results. Example process 500 includes one or more operations, actions, or functions as illustrated by one or more of blocks 502, 504 and 506. Although illustrated as discrete blocks, various blocks may be divided into additional blocks, combined into fewer blocks, or eliminated, depending on the desired implementation. Process 500 may be implemented by one or more processors including, for example, one or more processors of back-end device 102 and processor 404 of computing device 400. For illustrative purposes, the operations described below are performed by one or more processors of computing device 400 as shown in FIG. 4.

At 502, processor 404 of computing device 400 may determine a set of items as search results or candidates for recommendation. Each of the items in the set is associated with a respective first parameter representative of a measure of suitability of the respective item for a predefined purpose (e.g., recommendation). The items in the set are associated with a plurality of second parameters each of which representative of a measure of similarity between a respective one of the items and another respective one of the items.

At 504, processor 404 of computing device 400 may determine an order in which a subset of the items is to be displayed based at least in part on the respective first parameter associated with each of the items and the second parameters associated with the items.

At 506, processor 404 of computing device 400 may display the subset of the items in the determined order.

To illustrate, consider an example where an e-commerce user, e.g., user 106, would benefit from viewing recommended candidate items suitable to be purchased in view of the item of interest. In this example, processor 404 of computing device 400 can select from a set of candidate items a subset of candidate items, one or more of which may be sold together with the item of interest, e.g., as a bundle. Assuming the item of interest is a badminton racquet, the candidate items may include, among other things, another badminton racquet, racquet case, nylon shuttlecocks, badminton basics DVD and Olympics 2012 DVD. The above-listed five candidate items may be chosen from a larger pool of candidate items and displayed in a specific order as determined by processor 404 of computing device 400 implementing algorithms described in the present disclosure.

In one embodiment, a value of the respective first parameter associated with each of the items may be determined with respect to an item of interest. In one embodiment, the item of interest is an item viewed or purchased by a user on an e-commerce website, an item added to a wish list of a shopping cart of the user, or an item purchased offline in a physical store by the user.

In one embodiment, according to process 500, processor 404 of computing device 400 may receive an indication of a selection of the item of interest, determine the respective first parameter for each of the items, and determine the respective set of second parameters for the items.

In one embodiment, in determining an order in which a subset of the items is to be displayed, processor 404 of computing device 400 may determine a respective score associated with each of the items for each position in the determined order. In one embodiment, in determining a respective score associated with each of the items for each position in the determined order, processor 404 of computing device 400 computes a best cost arrangement using an equation as follows: C_{i,j}=φᵢ+max_{k:1≧k≦n}(C_{k,j-1}+Ψ_{k,i}), for j>1. In the above equation, denotes an i^{th} item of the set of items, 1≦i≦n; n denotes a quantity of items in the set of items, n≧1;j denotes a position in the order in which a subset of the items is to be displayed, 1<j≦p, where p is a quantity of items in the subset of the items, n>p; C_{i,j} denotes a best cost arrangement of the items up to position j that places item i in position j; φᵢ denotes a respective first parameter representative of a measure of suitability of the i^{th} item for the predefined purpose (e.g., recommendation); and Ψ_{k,i} denotes a respective one of the second parameters representative of a measure of similarity between a k^{th} item and the i^{th} item.

In one embodiment, in addition to determining a respective score associated with each of the items for each position in the determined order, processor 404 of computing device 400 may also determine a best item of the set of items for each position in the determined order.

In one embodiment, in determining a best item of the set of items for each position in the determined order, processor 404 of computing device 400 determines a best item of the set of items for each position in the determined order comprises computing max(C_{1,p}, C_{2,p}, . . . C_{n,p}). Additionally or alternatively, in determining a best item of the set of items for each position in the determined order, processor 404 of computing device 400 determines a respective best item of the set of items for a last position in the order. Processor 404 of computing device 400 then determines a respective best item of the set of items for a second-to-the-last position in the order. Processor 404 of computing device repeats this determination process for remaining positions in the order until a respective best item of the set of items for a first position in the order is determined.

In one embodiment, in displaying the subset of the items in the determined order, processor 404 of computing device 400 may display the respective best item of the set of items for each position in the determined order.

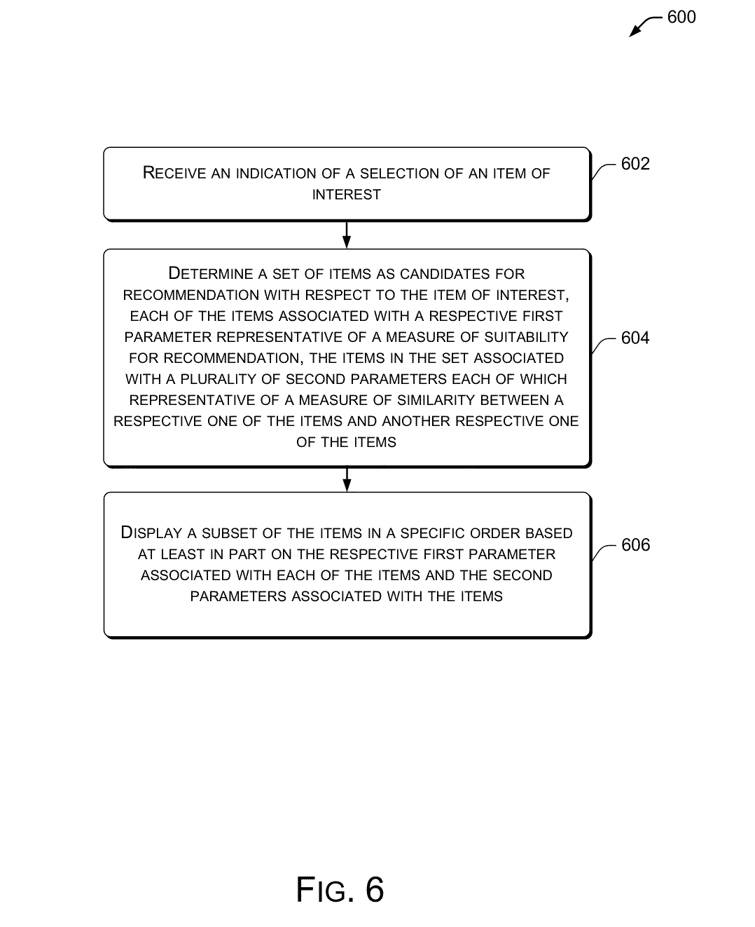

FIG. 6 illustrates an example process 600 for optimally ordering recommendation or search results. Example process 600 includes one or more operations, actions, or functions as illustrated by one or more of blocks 602, 604 and 606. Although illustrated as discrete blocks, various blocks may be divided into additional blocks, combined into fewer blocks, or eliminated, depending on the desired implementation. Process 600 may be implemented by one or more processors including, for example, one or more processors of back-end device 102 and processor 404 of computing device 400. For illustrative purposes, the operations described below are performed by processor 404 of computing device 400 as shown in FIG. 4.

At 602, processor 404 of computing device 400 may receive an indication of a selection of an item of interest.

At 604, processor 404 of computing device 400 may determine a set of items as search results or candidates for recommendation with respect to the item of interest. Each of the items in the set is associated with a respective first parameter representative of a measure of suitability of the respective item for a predefined purpose (e.g., recommendation). The items in the set are associated with a plurality of second parameters each of which representative of a measure of similarity between a respective one of the items and another respective one of the items.

At 606, processor 404 of computing device 400 may display a subset of the items in a specific order based at least in part on the respective first parameter associated with each of the items and the second parameters associated with the items.

As an example, processor 404 of computing device 400 receives an indication of a selection by an e-commerce user, e.g., user 106, of an item of interest. In this example, back-end device 102 can select from a set of candidate items a subset of candidate items, one or more of which may be sold together with the item of interest, e.g., as a bundle. Assuming the item of interest is a badminton racquet, the candidate items may include, among other things, another badminton racquet, racquet case, nylon shuttlecocks, badminton basics DVD and Olympics 2012 DVD. The above-listed five candidate items may be chosen from a larger pool of candidate items and displayed in a specific order as determined by processor 404 of computing device 400 implementing algorithms described in the present disclosure.

In one embodiment, according to process 600, processor 404 of computing device may further determine the respective first parameter for each of the items and the respective set of second parameters for the items.

In one embodiment, according to process 600, processor 404 of computing device may further determine the specific order in which the subset of the items is to be displayed based at least in part on the representative first parameter and the representative set of second parameters associated with the items.

In one embodiment, in determining the specific order in which the subset of the items is to be displayed, processor 404 of computing device 400 may determine a respective score associated with each of the items for each position in the specific order. In one embodiment, in determining a respective score associated with each of the items for each position in the specific order, processor 404 of computing device 400 computes a best cost arrangement using an equation as follows: C_{i,j}=φᵢ+max_{k:1≧k≦n} (C_{k,j-1}+Ψ_{k,i}), for j>1. In the above equation, i denotes an i^{th} item of the set of items, 1≦i≦n; n denotes a quantity of items in the set of items, n≧1; j denotes a position in the order in which a subset of the items is to be displayed, 1<j≦p, where p is a quantity of items in the subset of the items, n>p; C_{i,j} denotes a best cost arrangement of the items up to position j that places item i in position j; φᵢ denotes a respective first parameter representative of a measure of suitability of the i^{th} item for the predefined purpose (e.g., recommendation); and Ψ_{k,i} denotes a respective one of the second parameters representative of a measure of similarity between a k^{th} item and the i^{th} item.

In one embodiment, in addition to determining a respective score associated with each of the items for each position in the specific order, processor 404 of computing device 400 may also determine a best item of the set of items for each position in the specific order.

In one embodiment, in determining a best item of the set of items for each position in the specific order, processor 404 of computing device 400 determines a best item of the set of items for each position in the specific order comprises computing max(C_{1,p}, C_{2,p}, . . . C_{n,p}). Additionally or alternatively, in determining a best item of the set of items for each position in the specific order, processor 404 of computing device 400 determines a respective best item of the set of items for a last position in the order. Processor 404 of computing device 400 then determines a respective best item of the set of items for a second-to-the-last position in the order. Processor 404 of computing device repeats this determination process for remaining positions in the order until a respective best item of the set of items for a first position in the order is determined.

In one embodiment, in displaying the subset of the items in the specific order, processor 404 of computing device 400 may display the respective best item of the set of items for each position in the specific order.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. A method comprising:
determining, by one or more processors, a plurality of items as search results or candidates for recommendation, wherein:
each item of the plurality of items is associated with a respective first parameter representative of a measure of suitability for a predefined purpose, and
the plurality of items are associated with a plurality of second parameters, each second parameter of the plurality of second parameters representative of a measure of similarity between an item of the plurality of items and another item of the plurality of items;
determining, by the one or more processors, an order, which a subset of the plurality of items are to be displayed in, using a best cost arrangement algorithm based at least in part on the respective first parameter associated with the each item of the plurality of items and the second parameters associated with the plurality of items; and
displaying, the one or more processors, the subset of the plurality of items in the determined order.

2. The method of claim 1, wherein the respective first parameter is representative of a measure of suitability for recommendation, and wherein a value of the respective first parameter is determined with respect to an item of interest.

3. The method of claim 2, wherein the item of interest comprises an item viewed or purchased by a user on an e-commerce website, an item added to a wish list of a shopping cart of the user, or an item purchased in a physical store by the user.

4. The method of claim 2, further comprising:
receiving, by the one or more processors, an indication of a selection of the item of interest;
determining the respective first parameter for each time of the plurality of items; and
determining the plurality of second parameters for the plurality of items.

5. The method of claim 1, wherein the determining the order in which the subset of the plurality of items are to be displayed comprises determining a respective score associated with the each item of the plurality of items for each position in the determined order.

6. The method of claim 5, wherein the determining the respective score associated with the each item of the plurality of items for the each position in the determined order comprises computing a best cost arrangement of the each item of the plurality of items for the each position in the determined order using an equation as follows:
C_{i,j}=φᵢ+max_{k:1≧k≦n}(C_{k,j-1}+Ψ_{k,i}), for j>1
wherein:
i denotes an i^{th} item of the plurality of items, 1≦i≦n,
n denotes a quantity of items in the plurality of items, n≧1,
j denotes a position in an order in which the subset of the plurality of items is to be displayed, 1<j≦p, where p is a quantity of items in the subset of the plurality of items, n>p,
C_{i,j} denotes a best cost arrangement of the plurality of items up to position j that places item i in position j,
φᵢ denotes a respective first parameter representative of a measure of suitability of the i^{th} item for the predefined purpose, and
Ψ_{k,i} denotes a respective one of the second parameters representative of a measure of similarity between a k^{th} item and the i^{th} item.

7. The method of claim 5, further comprising:
determining a best item of the plurality of items for the each position in the determined order, the best item representative of a best cost arrangement of the plurality of item to the each position.

8. The method of claim 7, wherein the determining the best item of the plurality of items for the each position in the determined order comprises conducting a max operation on a plurality of costs of the plurality of items for the each position.

9. The method of claim 7, wherein the determining the best item of the plurality of items for the each position in the determined order further comprises:
determining a respective best item of the plurality of items for a last position in the determined order;
determining a respective best item of the plurality of items for a second-to-the-last position in the determined order; and
repeating the determining for remaining positions in the order until a respective best item of the plurality of items for a first position in the determined order is determined.

10. The method of claim 9, wherein the displaying the subset of the plurality of items in the determined order comprises displaying the respective best item of the plurality of items for the each position in the determined order.

11. A method comprising:
receiving, by one or more processors, an indication of a selection of an item of interest;
determining, by the one or more processors, a plurality of items as search results or candidates for recommendation with respect to the item of interest, wherein:
each item of the plurality of items is associated with a respective first parameter representative of a measure of suitability for a predefined purpose, and
the plurality of items are associated with a plurality of second parameters, each second parameter of the plurality of second parameters representative of a measure of similarity between an item of the plurality of items and another item of the plurality of items; and
displaying, by the one or more processors, a subset of the items in a specific order that is determined using a best cost arrangement algorithm based at least in part on the respective first parameter associated with each item of the items and the second parameters associated with the plurality of items.

12. The method of claim 11, further comprising:
determining, by the one or more processors, the respective first parameter for the each item of the plurality of items; and
determining the plurality of second parameters for the plurality of items.

13. The method of claim 11, further comprising:
determining the specific order in which the subset of the plurality of items is to be displayed based at least in part on the representative first parameter and the plurality of second parameters associated with the items.

14. The method of claim 13, wherein the determining the specific order in which the subset of the plurality of items is to be displayed comprises determining a respective score associated with each item of the plurality of items for each position in the specific order.

15. The method of claim 14, wherein the determining the respective score associated with the each item of the plurality of items for the each position in the specific order comprises computing a best cost arrangement of the each item of the plurality of for the each position in the specific order using an equation as follows:
C_{i,j}=φᵢ+max_{k:1≧k≦n}(C_{k,j-1}+Ψ_{k,i}), for j>1
wherein:
i denotes an i^{th} item of the plurality of items, 1≦i≦n,
n denotes a quantity of items in the plurality of items, n≧1,
j denotes a position in an order in which the subset of the plurality of items is to be displayed, 1<j≦p, where p is a quantity of items in the subset of the plurality of items, n>p,
C_{i,j} denotes a best cost arrangement of the plurality of items up to position j that places item i in position j,
φᵢ denotes a respective first parameter representative of a measure of suitability of the i^{th} item for the predefined purpose, and
Ψ_{k,i} denotes a respective one of the second parameters representative of a measure of similarity between a k^{th} item and the i^{th} item.

16. The method of claim 14, further comprising:
determining a best item of the plurality of items for the each position in the specific order.

17. The method of claim 16, wherein the determining the best item of the plurality of items for each position in the specific order comprises conducting a max operation on a plurality of costs of the plurality of items for the each position.

18. The method of claim 16, wherein the determining the best item of the plurality of items for the each position in the specific order further comprises:
determining a respective best item of the plurality of items for a last position in the determined order;
determining a respective best item of the plurality of items for a second-to-the-last position in the determined order; and
repeating the determining for remaining positions in the order until a respective best item of the set of items for a first position in the determined order is determined.

19. The method of claim 18, wherein the displaying the subset of the plurality of items in the specific order comprises displaying the respective best item of the plurality of items for the each position in the specific order.

20. An apparatus comprising:
a memory configured to store data and one or more sets of instructions; and
one or more processors coupled to the memory, the one or more processors configured to execute the one or more sets of instructions and perform operations comprising:
determining a plurality of items as candidates as search results for recommendation with respect to an item of interest, wherein:
each item of the plurality of items is associated with a respective first parameter representative of a measure of suitability of the each item for a predefined purpose, and
the plurality of items are associated with a plurality of second parameters, each second parameter of the plurality of second parameters representative of a measure of similarity between an item of the plurality of items and another item of the plurality of the items;
determining an order, which a subset of the plurality of items is to be displayed in using a best cost arrangement algorithm based at least in part on the representative first parameter associated with the each item of the plurality of items and the plurality of second parameters associated with the items; and
displaying the subset of the items in the determined order.
